(19) United States
(12) Patent Application Publication
(10) Pub. No.: US 2022/0228406 A1
(43) Pub. Date: Jul. 21, 2022

(54) COOLER SAFETY RELEASE DEVICE

(71) Applicant: Igloo Products Corp., Katy, TX (US)

(72) Inventors: Roque Barros, Katy, TX (US); Nicholas Dekeyser, Katy, TX (US)

(21) Appl. No.: 17/578,095

(22) Filed: Jan. 18, 2022

Related U.S. Application Data
(60) Provisional application No. 63/137,902, filed on Jan. 15, 2021.

(51) Int. Cl. E05C 1/06; E05C 1/00; E05B 65/52

(52) U.S. Cl. CPC E05C 1/06; B65D 81/3813; E05B 65/5238; E05C 1/006

(57) ABSTRACT

In several embodiments, a person trapped inside a cooler may utilize the cooler safety release device to escape. The person may place his fingers on a pull tab on the inner plate of the safety release device and slide the inner plate away from the outer plate to move the locking tab away from being immediately above the plate of the locking mechanism to being adjacent, but no longer overlapping, with the plate of the locking mechanism. In one or more embodiments, when the locking tab is positioned in a non-overlapping position with the plate of the locking mechanism, the lid is unlocked from the cooler body and is able to be opened, even by someone inside the cooler.

### RELATED APPLICATIONS

The present application claims the benefit of and priority to U.S. Provisional Application No. 63/137,902, entitled “COOLER SAFETY RELEASE DEVICE”, filed on Jan. 15, 2021, the entirety of which is incorporated herein by reference.

### TECHNICAL FIELD

The present invention generally relates to portable coolers, and more particularly to portable coolers having a safety release device.

### BACKGROUND

Over the past years, delivery service providers have developed contactless delivery storage solutions for the secure delivery of goods at a specific location. These storage solutions may be automated locker systems or other types of containers that delivery service providers can access to securely store goods for a consumer. Typically, these storage solutions include keyless entry for consumers, such that the consumer must enter an electronic code to cause the particular storage solution to open so that the consumer can retrieve the goods. As these storage solutions have been developed, storage solution providers have created multiple sizes of storage solutions. As such, there are storage solutions that are large enough to hold a child. Because these storage solutions utilize one-time electronic codes to open the storage solution, there exists a possibility that a child could get accidentally stuck inside a storage solution. Therefore, there is a need for a storage solution safety release device.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a rear perspective view of a cooler having an exemplary safety release device attached thereto, according to one embodiment of the present disclosure;

FIG. 2 is a perspective view of a cooler having an exemplary safety release device attached thereto, according to one embodiment of the present disclosure;

FIG. 3A is an upward internal perspective view of a cooler having an exemplary safety release device attached thereto, according to one embodiment of the present disclosure;

FIG. 3B is an upward internal perspective view of a cooler having an exemplary safety release device attached thereto, according to one embodiment of the present disclosure;

FIG. 3C is an upward internal perspective view of a cooler having an exemplary safety release device attached thereto, according to one embodiment of the present disclosure;

FIG. 4A is a front perspective view of an exemplary safety release device, according to one embodiment of the present disclosure;

FIG. 4B is a front perspective view of an exemplary safety release device, according to one embodiment of the present disclosure;

FIG. 4C is a front perspective view of an exemplary safety release device, according to one embodiment of the present disclosure;

FIG. 5A is a rear perspective view of an exemplary safety release device, according to one embodiment of the present disclosure;

FIG. 5B is a rear perspective view of an exemplary safety release device, according to one embodiment of the present disclosure;

FIG. 5C is a rear perspective view of an exemplary safety release device, according to one embodiment of the present disclosure;

FIG. 6 is a rear perspective view of an alternative exemplary safety release device, according to one embodiment of the present disclosure;

FIG. 7 is a front view of an alternative exemplary safety release device, according to one embodiment of the present disclosure;

The drawings illustrate only exemplary embodiments of the invention and are therefore not to be considered limiting of its scope, as the invention may admit to other equally effective embodiments.

### DETAILED DESCRIPTION OF EXEMPLARY EMBODIMENTS

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

Aspects of the present disclosure generally relate to portable coolers, and more particularly to portable coolers having a safety release device. In certain exemplary embodiments, a cooler 102 may include a cooler body 104 and a lid 106. In various embodiments, the lid 106 may be coupled to the top of the cooler body 104 in any number of ways, such as by use of a hinge and/or a latch. In several embodiments, the cooler 102 may be of a different size or shape than described herein and the cooler body 104 may be coupled to the lid 106 in a different manner than described herein. In some embodiments, the cooler body 104 may be in one or more of a number of different cooler sizes with various lengths, widths, heights, geometrical and non-geometrical shapes and/or capacities, so long as the lid 106 is lockable to the body 104. In certain exemplary embodiments, the cooler 102 may be fabricated using different colors, accents, and/or different personalizations, such as by laser etching or silk screening across one or more of the cooler surfaces. In at least one embodiment, the cooler 102 may be fabricated in various different materials, such as rubber, plastics, stainless steel, other polymers, and other metals in one or more fabricated parts of the cooler 102. In one or more embodiments, the portable cooler 102 may include other known features including but not limited to wheels or rollers, lights, various handle types, and speakers. Although the exemplary embodiments of the safety release device 100 have been shown in conjunction with a lockable cooler, other embodiments may use the safety release device 100 in conjunction with other lockable container type, such as a locker, safe, and any other container that a person can fit into. In multiple embodiments, the safety release device 100 may be used in the event that someone gets locked and trapped within the cooler 102, or another container. In some embodiments, the safety release device 100 allows the person trapped inside the cooler 102, or container, to unlock the lid 106 from the cooler body 104 and escape from the cooler 102.

Exemplary embodiments of the safety release device 100 will now be described more fully hereinafter with reference to the accompanying drawings, in which exemplary embodiments of the portable cooler and the safety release devices are shown. In several embodiments, the safety release device 100 and cooler 102 may be embodied in many different forms and should not be construed as limited to the exemplary embodiments set forth herein. Rather, these exemplary embodiments are provided so that this disclosure will be thorough and complete, and will fully convey the scope of the portable cooler and the safety release device to those people having ordinary skill in the art. Like, but not necessarily the same, elements in the various figures are denoted by like reference numerals for consistency.

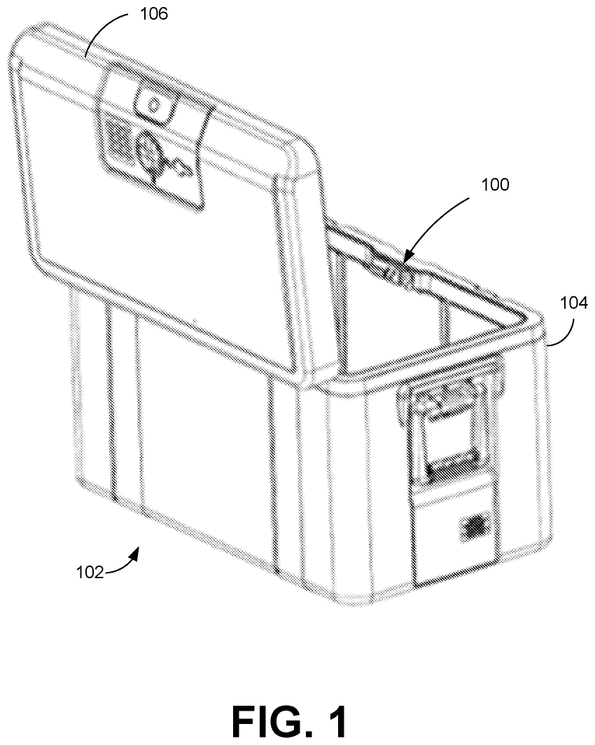

Referring now to the figures, for the purposes of example and explanation of the fundamental processes and components of the disclosed devices, reference is made to FIG. 1, which illustrates a rear perspective view of a cooler 102 having an exemplary safety release device 100 attached thereto. In multiple embodiments, the cooler 102 may include a safety release device 100 that allows for a person who is trapped within the locked cooler 102 to operate the safety release device 100 so that the lid 106 can be unlocked from the cooler body 104 and the person trapped can lift open the lid 106 from inside the cooler 102.

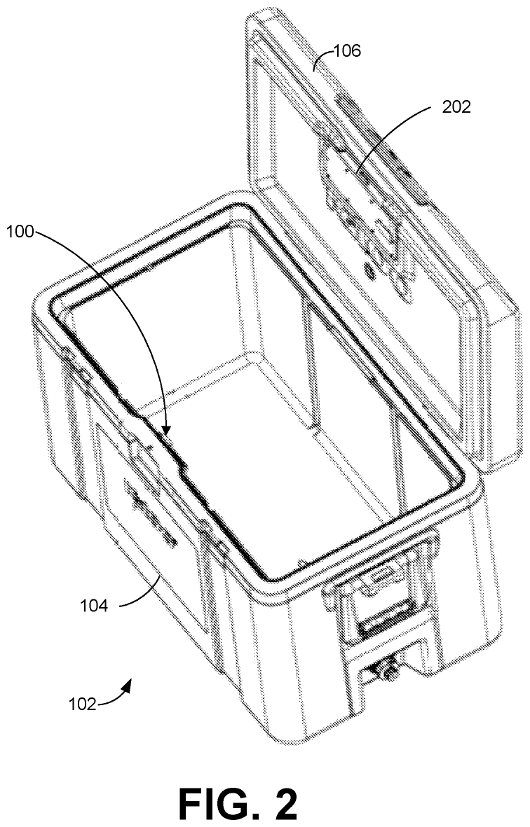

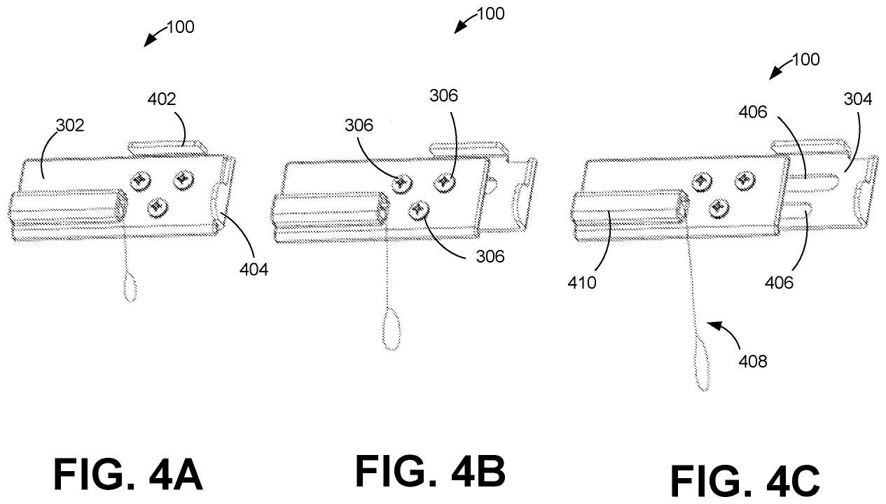

In several embodiments, as shown in FIG. 1, the safety release device 100 may be attached to the inside portion of the cooler body 104. In one or more embodiments, the cooler 102 may include a locking mechanism 202 (as shown in FIG. 2) on the lid 106. In at least one embodiment, the locking mechanism 202 may interact with the (as shown FIG. 4A), to lock the lid 106 onto the cooler body 104. For example, in many embodiments, when a user closes the lid 106 onto the cooler body 104, the locking mechanism 202 may actuate to cause a plate to slide underneath the locking tab 402, such that the lid 106 is locked onto the body 104. In one or more embodiments, the locking mechanism 202 may be actuated in various ways, such as a turn knob, a solenoid actuator, or any other mechanism that one having ordinary skill in the art would utilize to cause the lid 106 to be locked on to the cooler body 104.

Referring now to FIG. 2, a perspective view of a cooler 102 having an exemplary safety release device 100 attached thereto is shown, according to one embodiment of the present disclosure. The locking mechanism 202 can be disposed on the underside side of the lid 106. In at least one embodiment, for example, the locking mechanism 202 may include a turn knob that may rotate clockwise and counterclockwise to place the lid 106 in a locked position and an unlocked position. Continuing with the example, in several embodiments, when the turn knob is positioned in the locked position, the plate located on the underside of the lid 106 can be moved forward in the direction towards the front of the cooler 102 to fit below the locking tab 402 of the safety release device 100, thereby locking the lid to the cooler body 104 and preventing the opening of the lid 106. In one or more embodiments, once the turn knob is rotated and positioned in the unlocked position, the plate located on the underside of the lid 106 can be moved backwards in the direction towards the rear of the cooler 102 to move away from the locking tab 402 (FIG. 4A) of the safety release device 100 that prevented the opening of the lid 106 from the cooler body 104, thereby unlocking the lid 106 from the cooler body 104 and allowing the lid 106 to open. In some embodiments, the plate within the locking mechanism 202 can be moved by a solenoid actuator or other electronically enabled actuator.

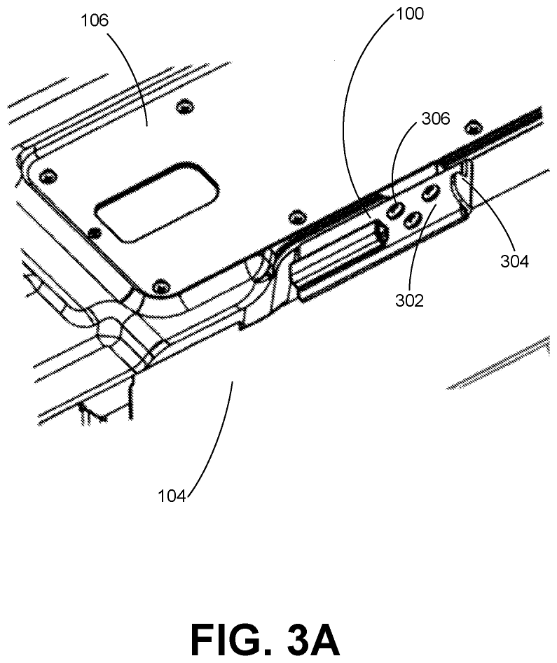

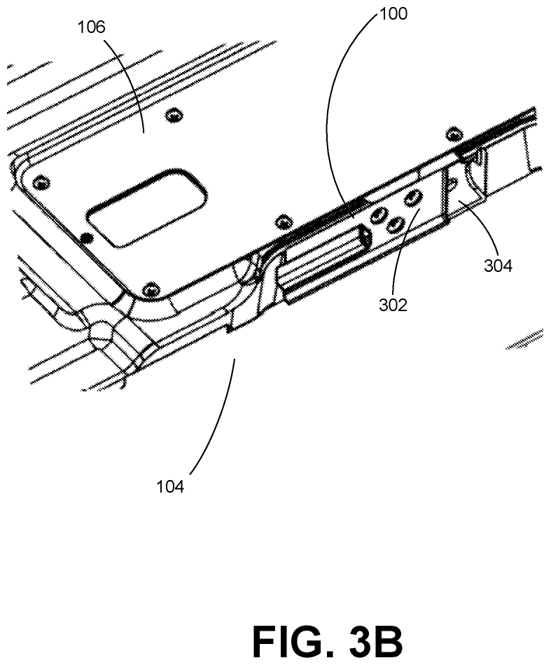

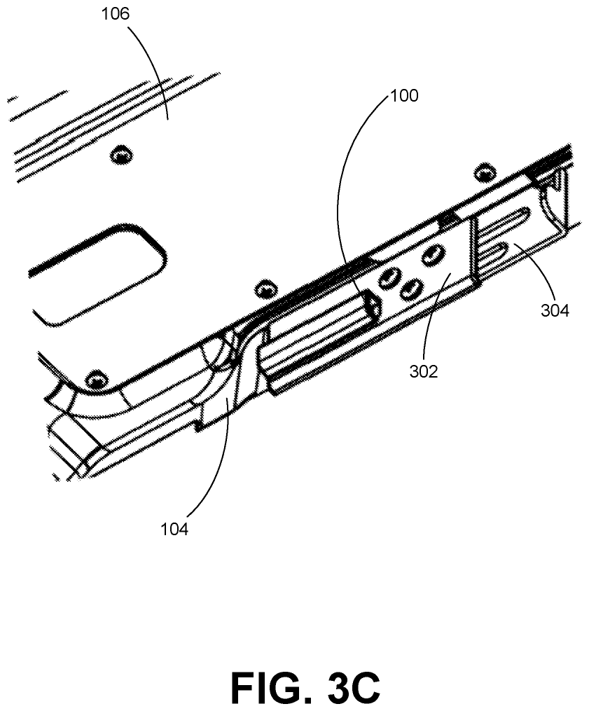

Referring now to FIGS. 3A, 3B, and 3C, upward internal perspective views of a cooler 102 having an exemplary safety release device 100 attached thereto are shown, according to one embodiment of the present disclosure. The internal perspective views as shown in FIGS. 3A, 3B, and 3C are representative of the view a person would have if trapped in the cooler 102. In various embodiments, in the event a person is trapped within the cooler 102 and the lid 106 is locked to the cooler body 104, the person may operate the safety release device 100 located in the interior of the cooler 102 near the top edge of the front of the cooler body 104. In many embodiments, the safety release device 100 is mounted to the interior side of the cooler body 104 near the upper ends of the front side using one or more fasteners 306, such as screws, nails, rivets, magnets, or any other type of fastening element. In an alternative embodiment, the safety release device 100 may be mounted in an indentation on the interior side of the cooler body 104 and secured using overlapping ridges around the edges of the safety release device 100, with or without the one or more fasteners 306. In one or more embodiments, the safety release device 100 can be rectangular shaped and include an outer plate 302 and an inner plate 304, where the outer plate 302 is mounted to the cooler body 104 using the one or more fasteners 306, and the inner plate 304 may slide horizontally in an inward and outward direction with respect to the outer plate 302.

In one or more embodiments, as shown in FIG. 3A, when the lid 106 is closed and locked to the cooler body 104, the inner plate 304 can be pushed in to the outer plate 302 so that the locking tab 402 is operatively connected with the plate of the locking mechanism 202, such that the lid 106 may not be raised because the locking tab 402 blocks the plate on the locking mechanism 202. As shown in FIG. 3A, in an exemplary embodiment, the safety release device 100 is in a locked position.

In many embodiments, as shown in FIG. 3B, the safety release device 100 may be in an intermediate locked position. In some embodiments, the intermediate locked position may prevent the lid 106 from being opened. As shown in FIG. 3B, in an exemplary embodiment, the inner plate 304 may be pulled away from the outer plate 302. In one embodiment, as the inner plate 304 is moved horizontally away from the outer plate 302, the locking tab 402 is moved away from the plate on the locking mechanism 202.

In multiple embodiments, as shown in FIG. 3C, the safety release device 100 is in an unlocked position, such that a person trapped inside the cooler 102 may push the lid open to escape from the cooler 102. As shown in FIG. 3C, in at least one embodiment, the inner plate 304 is pulled horizontally away from the outer plate 302 to an unlocked position in which the locking tab 402 does not obstruct the plate of the locking mechanism. In some embodiments, the unlocked position may be the position at which the locking tab 402 no longer obstructs the lid 106 from opening, and may be when the inner plate 304 is fully extended away from the outer plate 302 or the position where the locking tab 402 obstruction is cleared.

Referring now to FIGS. 4A, 4B, and 4C, a front perspective view of an exemplary safety release device is shown, according to one embodiment of the present disclosure. As shown in FIGS. 4A, 4B, and 4C, in one or more embodiments, the safety release device 100 is shown in a locked position (FIG. 4A), an intermediate position (FIG. 4B), and an unlocked position (FIG. 4C). In multiple embodiments, the safety release device 100 shown in FIGS. 4A, 4B, and 4C generally corresponds to the safety release device 100 shown FIGS. 3A, 3B, and 3C, respectively.

In several embodiments, as shown in FIGS. 4A, 4B, and 4C, the inner plate 304 may include a locking tab 402 protruding from the upper edge of the inner plate 304, a pull tab 404 protruding from one longitudinal end of the inner plate that may be utilized to move the inner plate 304 towards or away from the outer plate 302, and at least one longitudinal track opening 406 allowing the one or more fasteners 306 to pass through to couple the outer plate 302 to the cooler body 104. In the exemplary embodiment, as shown in FIGS. 4A, 4B, and 4C, the inner plate 304 defines two such longitudinal track openings 406 that are formed being parallel to one another. In many embodiments, the fasteners 306 provide a stop to prevent the inner plate 304 from sliding too far outward and decoupling from the outer plate 302 and too far inward.

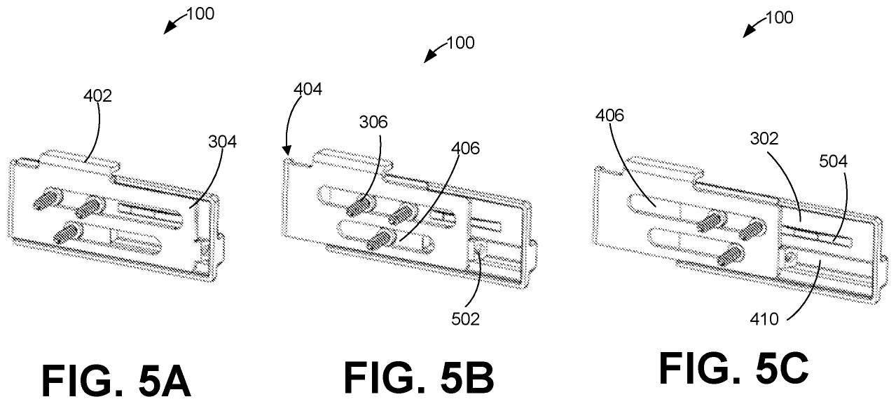

In various embodiments, the outer plate 302 may define openings for allowing fasteners 306 to pass through and couple the outer plate 302 to interior of the cooler body 104, with the inner plate 304 coupled in between the outer plate 302 and the cooler body 104. In some embodiments, the fastener devices 306 may include spacers or washers located in between the rear surface of the outer plate 302 and the front surface of the inner plate 304, creating a small gap between the inner plate 304 and the outer plate 302. In some embodiments, the inner plate 304 may include a cord coupler 502 (as shown in FIGS. 5A, 5B, and 5C) that defines a cord coupler opening whereby a cord 408 may connect. In one embodiment, the outer plate 302 may include a hollow, rectangular cord protector 410 that protrudes from the front of the outer plate 302. In many embodiments, the cord coupler 502 may protrude from the front of the inner plate 304 into the cord protector 410, in which the cord protector 410 acts as a track for the cord coupler 502 to slide within as the inner plate 304 is moved away from the outer plate 302. In at least one embodiment, the cord 408 may attach to the inner plate 304, and the person trapped in the cooler 102 may pull the cord 408 to slide the inner plate 304 away from the outer plate 302, thereby unlocking the lid 106. In one or more embodiments, the hollow cord protector 410 may also include an opening formed therein that extends to the rear end of the cord protector and through the outer plate. In some embodiments, the cord 408 may be connected to the cord coupler 502, with some length of the cord 408 residing within the hollow cord protector 410, and the end of the cord 408 emerging from the opening of the cord protector 410. In one embodiment, the cord protector 410 may be formed with a back wall at the rear end opposing the opening in which the cord 408 goes through. In several embodiments, the opening within the cord protector 410 allows the cord 408, which is optional, to be inserted into the cord protector 410 through the opening and extend to the inner plate 304, and more specifically through the opening formed in the cord coupler 502, where the end of the cord 408 in connected. In one or more embodiments, the end of the cord 408 may be connected to the cord coupler 502 by being tied around the cord coupler 502, or the cord 408 may have a knot formed at the end of the cord 408 so that the knot abuts the opening formed in the cord coupler 502 and is unable to pass through the cord coupler opening.

Referring now to FIGS. 5A, 5B, and 5C, a rear perspective view of an exemplary safety release device 100 is shown, according to one embodiment of the present disclosure. As shown in FIGS. 5A, 5B, and 5C, in one or more embodiments, the safety release device 100 is shown in a locked position (FIG. 5A), an intermediate position (FIG. 5B), and an unlocked position (FIG. 5C). In multiple embodiments, the safety release devices 100 shown in FIGS. 5A, 5B, and 5C generally correspond to the safety release devices 100 shown FIGS. 4A, 4B, and 4C, respectively.

In some embodiments, the cord protector 410 may include a track, or function as a track, which allows for the portion of the cord coupler 502 protruding from the front surface of the inner plate 304 to slide within the track. In at least one embodiment, as shown in FIGS. 5A, 5B, and 5C, the outer plate 302 may also have a safety ramp 504 that protrudes outwardly from the rear surface of the outer plate 302 towards the front surface of the inner plate 304, above the cord protector 410; however, in other embodiments, the safety ramp may be below the cord protector 410 or on the inner surface of the cord protector 410. In several embodiments, the safety ramp 504 is a horizontal narrow strip of material that may include a first section, a second section, and a third section and extends from a first end to a second end. In one embodiment, the first end of the safety ramp 504 may be near or proximate to one end of the outer plate 302, and the second end of the safety ramp 504 may be some length, for example, 0.1 to 5.0 centimeters, from the first end of the safety ramp 504, and located toward the opposite end of the outer plate 302. In one or more embodiments, the safety ramp 504 may be made of metal, PVC, plastic, or any other material that allows the safety ramp 504 to perform as discussed herein.

In at least one embodiment, the first section of the safety ramp 504 may start at the first end of the safety ramp 504 and extend to the beginning of the second section of the safety ramp 504. In many embodiments, the first section of the safety ramp 504 may protrude at an increasing elevation from the rear surface of the outer plate 302 as the first section extends from a first end to the second section. In some embodiments, the second section of the safety ramp 504 protrudes at a constant elevation from the rear surface of the outer plate 302 as the second section extends from the first section to the third section. In one or more embodiments, the third section of the safety ramp 504 protrudes at a decreasing elevation from the rear surface of the outer plate 302 as the third section extends from the second section to the second end. In many embodiments, the first end and the second end of the safety ramp 504 may have a height of 0 inches relative to the rear surface of the outer plate 302, and the second section may have a height of 0.01 to 1.0 centimeters, which the first section and the second section of the safety ramp 504 extend thereto.

In various embodiments, the shape of the safety ramp 504 may prevent the inner plate 304 from freely sliding from the locked position to the unlocked position or the unlocked position to the locked position. In one embodiment, a larger horizontal force may be applied to the inner plate 304 to move the inner plate 304 up and across the first and second sections of the safety ramp 504 (from the locked position to the unlocked position), relative the smaller horizontal force that may be used to move the inner plate 304 if the safety ramp 504 is not on the outer plate 302. In at least one embodiment, the second section of the safety ramp 504 may be raised to a certain level to interfere with the ease of sliding of the inner plate 304 over the second section. For example, in one embodiment, a user has to intentionally want to change the locking status, or position status, of the inner plate 304 to a locked or unlocked position since the second section of the safety ramp 504 provides some friction between the inner plate 304 and the outer plate 302. In many embodiments, the safety ramp 504 provides a mechanism to prevent the unintentional locking or unlocking of the lid 106 to the cooler body 104 to assist in preventing someone from accidentally getting trapped within the cooler 102.

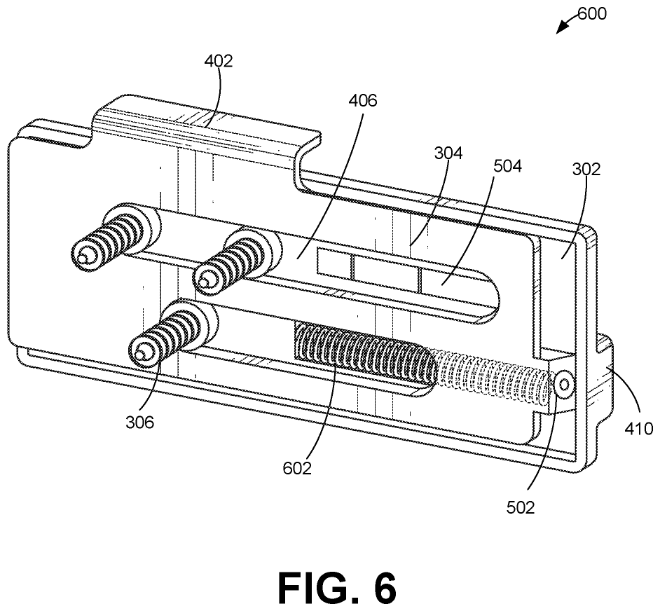

Turning now to FIG. 6, shown is a rear perspective view of an alternative exemplary safety release device 600, according to one embodiment of the present disclosure. In several embodiments, the safety release device 600 may include an outer plate 302 and an inner plate 304. In one or more embodiments, the outer plate 302 of safety release device 600 may include a cord protector 410 protruding from the front surface of the outer plate 302 and a safety ramp 504 protruding from the rear surface of the outer plate 302. In some embodiments, the inner plate 304 may include a locking tab 402, and at least one longitudinal track openings 406. In one or more embodiments, the safety release device 600 may include either or both of a pull tab 404 protruding from an end of the inner plate 304 and a cord 408 attached to a cord coupler 502 that is attached to the rear end of the inner plate 304. In many embodiments, in the safety release device 600, the outer plate 302 and the inner plate 304 are connected to the cooler body 104 via one or more fasteners 306 as described above.

In various embodiments, the safety release device 600 may also include a spring 602 that is attached to the inner plate 304 and the outer plate 302. In one or more embodiments, when the safety release device 600 is in the locked position, the spring 602 may be in a relaxed state, such that the spring 602 is exerting minimal or no force on the inner plate 304 and the outer plate 302. In at least one embodiment, when the inner plate 304 is moved horizontally away from the outer plate 302 (from a locked to an unlocked position), the spring 602 may compress, such that when a user stops intentionally unlocking the safety release device 600, the spring 602 decompresses and causes the inner plate 304 to side back towards the outer plate 302 and into the locked position.

In multiple embodiments, the spring 602 include a first end and a second end. In one or more embodiments, the first end may be attached to the inner plate at the cord protector 410 or cord coupler 502, or any other point on the inner plate such that the spring 602 functions as described herein. In at least one embodiment, the second end of the spring 602 may be attached to the outer plate so that the second end of the spring 602 is stationary while the first end of the spring 602 moves with the inner plate 304. In some embodiments, the spring 602 may be attached to the inner plate 304 and outer plate 302 by screws, rivets, welding, or any other attachment mechanism known to one having ordinary skill in the art. In one embodiment, the safety release device 600 may include a cord 408 attached to a cord coupler 502, wherein the cord 408 may traverse through the cord protector 410 and either inside the inner circular opening of the spring 602 or to the side of the spring 602.

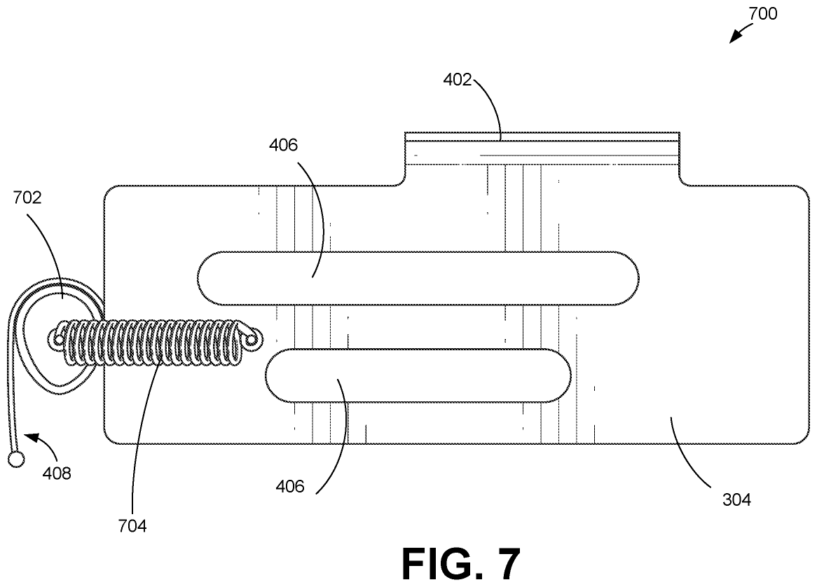

Turning now to FIG. 7, shown is a front view of an alternative exemplary safety release device 700, according to one embodiment of the present disclosure. In several embodiments, the safety release device 700 may include an inner plate 304, and may include an outer plate 302 (not shown) connected to the inner plate 304 and to the cooler body 104 via fasteners 306 (not shown), as previously described. In one or more embodiments, safety release device 700 may include a rotating member 702 such as a crank, gear or other member that can translate a “pull” on the cord 408 into the correct type/direction to override the locking mechanism 202. The rotating member 702 can be connected to the inner plate 304 via spring 704. In at least one embodiment, the rotating member 702 may be connected to the outer plate 302 or the cooler body 104, so that the rotating member does not move laterally when the safety release device 700 is moved between the locked and unlocked positions. In one embodiment, the cord 408 may be attached at a point on the edge of the rotating member 702, so that when the cord 408 is pulled, the rotating member 702 rotates against a spring tension provided by the spring 704. As shown in FIG. 7, in the exemplary embodiment, a pull force applied to the cord 408 causes the rotating member 702 to rotate counterclockwise; however, an embodiment in which the rotating member 702 rotates clockwise is also envisioned. In many embodiments, the spring 704 is connected to the rotating member 702 at the center of rotation, where the rotating member 702 is attached to the outer plate 302 or the cooler body 104, so that the end of the spring 704 attached to the rotating member 702 is stationary. In the exemplary embodiment, the spring 704 may be in a relaxed state when the safety release device 700 is in the locked position.

In one embodiment, the rotating member 702 may be a mechanical crank or cam that converts rotational motion into linear motion. In the exemplary embodiment shown in FIG. 7, the rotating member 702 is oblong, such that when the rotating member 702 rotates, a horizontal force is exerted onto the inner plate 304 due to the shape of the rotating member 702, causing the inner plate 304 to move from the locked to the unlocked position. In some embodiments, if a person exerts a force on the safety release device 700 (e.g., pulling the cord 408, pulling the pull tab 404), the inner plate 304 can move from the locked to the unlocked position, the inner plate 304 moves away from the center of rotation of the rotating member 702, causing the spring 704 to elongate. In at least one embodiment, the elongation of the spring 704 creates tension in the spring 704, and if the person ceases pulling the cord 408 or pulling the pull tab 404, the spring 704 constricts back to the relaxed state, which causes the inner plate 304 to slide back towards the outer plate 302 and back into the locked position. In other embodiments, the rotating member 702 may be circular rather than oblong, and the center of rotation may be off center, such that a horizontal force may be applied to the inner plate 304. In various other embodiments, other mechanisms, such as gear systems or other mechanical cam embodiments that turn rotational motion into linear motion may be utilized in the safety release device 700.

In multiple embodiments, the operation of the safety release device 100 is described below. In at least one embodiment, in the event a person is trapped inside the locked cooler 102 (e.g., lid 106 locked on cooler body 104 via locking mechanism 202 and locking tab 402), the safety release device 100 may be in the locked position and the plate on the locking mechanism 202 on the underside of the lid 106 may be pushed outwardly towards the front of the cooler 102 such that the plate slides into a position below the locking tab 402 of the safety release device 100, thereby preventing the opening of the lid 106. In several embodiments, the person inside the cooler may place his fingers on the pull tab on the inner plate 304 on the safety release device 100 and slide the inner plate 304 away from the outer plate 302 to move the locking tab 404 away from being immediately above the plate of the locking mechanism 202 to being adjacent, but no longer overlapping, with the plate of the locking mechanism 202. In one or more embodiments, when the locking tab 402 is positioned in a non-overlapping position with the plate of the locking mechanism 202, the lid 106 is unlocked from the cooler body 104 and is able to be opened, even by someone inside the cooler.

According to another embodiment, the person inside the cooler 102 is able to place his fingers on the cord 408 that hangs from the cord protector 410, and which passes to and through the opening formed in the cord coupler 502. In some embodiments, the cord 408 may be knotted such that the knot does not pass through the opening of the cord coupler 502. In certain embodiments, the person is able to pull on the cord 408 which causes the inner plate 304 of the safety release device 100 to slide outwardly away from the outer plate 302 and move the position of the locking tab 402 from being immediately above the plate of the locking mechanism 202 to being adjacent, but no longer overlapping, with the plate of the locking mechanism 202. In at least one embodiment, when the locking tab 402 is positioned in a non-overlapping position with the plate of the locking mechanism on the lid 106, the lid 106 is unlocked from the cooler body 104 and is able to be opened, even by someone inside the cooler 102.

Other features shown in the drawings are part of embodiments of the invention even if not specifically described above.

Accordingly, many modifications and other embodiments set forth herein will come to mind to one skilled in the art to which portable nesting coolers pertain having the benefit of the teachings presented in the foregoing descriptions and the associated drawings. Therefore, it is to be understood that these portable nesting coolers are not to be limited to the specific embodiment disclosed and that modifications and other embodiments are intended to be included within the scope of this application. Although specific terms are employed herein, they are used in a generic and descriptive sense only and not for purposes of limitation.

What is claimed is:

1. A cooler safety release device, comprising:
a first plate having a first plate front side and a first plate back side, wherein the first plate is attached to a cooler body by one or more fasteners, the first plate further comprising:
a locking tab, wherein the locking tab engages with an opposing locking mechanism on a cooler lid to lock the cooler lid to the cooler body;
at least one horizontal track opening; and
a pull tab for pulling the first plate horizontally, wherein the locking tab disengages with the opposing locking mechanism, thereby unlocking the cooler lid from the cooler body.

2. The cooler safety release device of claim 1, further comprising:
a stationary second plate having a second plate front side and a second plate back side, wherein the second plate back side is connected to the first plate front side by the one or more fasteners.

3. The cooler safety release device of claim 2, further comprising:
a spring having a first end and a second end, wherein the first end is attached to the first plate and the second end is attached to the stationary second plate.

4. The cooler safety release device of claim 2, further comprising:
a safety ramp protruding from the second plate back side, the safety ramp further comprising:
a first section, wherein a height of the first section increases from an initial height of zero to a particular height;
a second section, wherein the second section protrudes at the particular height; and
a third section, wherein the height of the third section decreases from the particular height to an end height of zero.

5. A cooler safety release device, comprising:
a first plate having a first plate front side and a first plate back side, wherein the first plate is attached to a cooler body by one or more fasteners, the first plate further comprising:
a locking tab, wherein the locking tab engages with an opposing locking mechanism on a cooler lid to lock the cooler lid to the cooler body;
at least one track opening; and
a cord coupler proximate to an end of the first plate; and
a cord attached to the cord coupler, wherein pulling the cord causes the first plate to move horizontally, wherein the locking tab disengages with the opposing locking mechanism, thereby unlocking the cooler lid from the cooler body.

6. The cooler safety release device of claim 5, further comprising:
a stationary second plate having a second plate front side and a second plate back side, wherein the second plate back side is connected to the first plate front side by the one or more fasteners.

7. The cooler safety release device of claim 6, further comprising:
a spring having a first end and a second end, wherein the first end is attached to the first plate and the second end is attached to the stationary second plate.

8. The cooler safety release device of claim 6, further comprising:
a safety ramp protruding from the second plate back side, the safety ramp further comprising:
a first section, wherein a height of the first section increases from an initial height of zero to a particular height;
a second section, wherein the second section protrudes at the particular height; and
a third section, wherein the height of the third section decreases from the particular height to an end height of zero.

9. A cooler safety release device, comprising:
a first plate having a first plate front side and a first plate back side, wherein the first plate is attached to a cooler body by one or more fasteners, the first plate further comprising:
a locking tab, wherein the locking tab engages with an opposing locking mechanism on a cooler lid to lock the cooler lid to the cooler body;
a stationary second plate having a second plate front side and a second plate back side, wherein the second plate back side is connected to the first plate front side by the one or more fasteners;
a rotating member adjacent to an end of the first plate and connected to the stationary second plate, the rotating member further comprising:
a cord connector proximate to an edge of the rotating member; and
a center of rotation that the rotating member rotates around;
a spring having a first end and a second end, wherein the first end of the spring is attached to the rotating member and the second end of the spring is attached to the first plate; and
a cord attached to the cord connector on the rotating member, wherein pulling the cord causes the rotating member to rotate thereby causing the first plate to move horizontally, wherein the locking tab disengages with the opposing locking mechanism, thereby unlocking the cooler lid from the cooler body.

10. The cooler safety release device of claim 9, wherein the rotating member is oblong.

11. The cooler safety release device of claim 9, wherein the rotating member is circular, and the center of rotation is not the center of the circular rotating member.

12. The cooler safety release device of claim 9, further comprising:
a safety ramp protruding from the second plate back side, the safety ramp further comprising:
a first section, wherein a height of the first section increases from an initial height of zero to a particular height;
a second section, wherein the second section protrudes at the particular height; and
a third section, wherein the height of the third section decreases from the particular height to an end height of zero.
